(19) United States
(12) Patent Application Publication
(10) Pub. No.: US 2013/0096231 A1
(43) Pub. Date: Apr. 18, 2013

(54) MASTERBATCH COMPOSITION

(71) Applicants: Satish V. Awate, Navi Mumbai (IN); Brad A. Cobler, Lake Jackson, TX (US); Rajen M. Patel, Lake Jackson, TX (US)

(72) Inventors: Satish V. Awate, Navi Mumbai (IN); Brad A. Cobler, Lake Jackson, TX (US); Rajen M. Patel, Lake Jackson, TX (US)

(73) Assignee: Dow Global Technologies LLC., Midland, MI (US)

(21) Appl. No.: 13/805,442

(22) PCT Filed: Jun. 17, 2011
(86) PCT No.: PCT/US2011/040863

§ 371 Date: Dec. 19, 2012

Related U.S. Application Data
(60) Provisional application No. 61/357,633, filed on Jun. 23, 2010.

(51) Int. Cl. C08K 3/26; C08L 23/14

(52) U.S. Cl. CPC C08K 3/26; C08L 23/142
USPC 523/351; 524/427; 264/500

(57) ABSTRACT

The instant invention provides a masterbatch composition, method of producing the same, polymeric compositions suitable for films, and films made therefrom. The masterbatch composition according to the present invention comprises: (a) from 70 to 90 percent by weight of a filler comprising calcium carbonate; and (b) from 10 to 30 percent by weight of a propylene/alpha-olefin copolymer composition, wherein said propylene/alpha-olefin copolymer composition has a crystallinity in the range of from 1 percent by weight to 30 percent by weight, a heat of fusion in the range of from 2 Joules/gram to 50 Joules/gram, and a DSC melting point in the range of 25° C. to 110° C.

### CROSS-REFERENCE TO RELATED APPLICATIONS

This application is a non-provisional application claiming priority from the U.S. Provisional Patent Application No. 61/357,633, filed on Jun. 23, 2010 entitled “MASTERBATCH COMPOSITION,” the teachings of which are incorporated by reference herein, as if reproduced in full hereinbelow.

### FIELD OF INVENTION

The instant invention relates to a masterbatch composition, method of producing the same, polymeric compositions suitable for films, and films made therefrom.

### BACKGROUND OF THE INVENTION

The use of highly filled linear low density polyethylene (LLDPE) based masterbatches with calcium carbonate is generally known in polyethylene-based film applications such as grocery bags, garbage bags, shopping bags, liners, wrapping sheets, and the like, to reduce the cost. However, the addition of currently available highly filled LLDPE based masterbatches with calcium carbonate to polyethylene composition suitable for films adversely affects toughness properties e.g. dart impact strength, of such polyethylene-based films.

Therefore, there is a need for a masterbatch composition suitable as a filler carrier, i.e. having high levels of calcium carbonate, which does not adversely affect toughness properties e.g. dart impact strength, of polyethylene-based films.

### SUMMARY OF THE INVENTION

The instant invention provides a masterbatch composition, method of producing the same, polymeric compositions suitable for films, and films made therefrom.

In one embodiment, the instant invention provides a masterbatch composition comprising: (a) from 70 to 90 percent by weight of a filler comprising calcium carbonate; and (b) from 10 to 30 percent by weight of a propylene/alpha-olefin copolymer composition, wherein said propylene/alpha-olefin copolymer composition has a crystallinity in the range of from 1 percent by weight to 30 percent by weight, a heat of fusion in the range of from 2 Joules/gram to 50 Joules/gram, and a DSC melting point in the range of 25° C. to 110° C.

In an alternative embodiment, the instant invention further provides a method for producing a masterbatch composition comprising the steps of (1) selecting a filler comprising calcium carbonate; (2) selecting a propylene/alpha-olefin copolymer composition, wherein said propylene/alpha-olefin copolymer composition has a crystallinity in the range of from 1 percent by weight to 30 percent by weight, a heat of fusion in the range of from 2 Joules/gram to 50 Joules/gram, and a DSC melting point in the range of 25° C. to 110° C.; (3) compounding that filler into said propylene/alpha-olefin copolymer composition; and (4) thereby producing said masterbatch composition, wherein said masterbatch composition comprises from 70 to 90 percent by weight of the filler and from 10 to 30 percent by weight of said propylene/alpha-olefin copolymer composition.

In another alternative embodiment, the instant invention further provides a polymeric composition suitable for films comprising: (a) from 10 to 40 percent by weight of a masterbatch composition comprising: from 70 to 90 percent by weight of a filler comprising calcium carbonate; and from 10 to 30 percent by weight of a propylene/alpha-olefin copolymer composition, wherein said propylene/alpha-olefin copolymer composition has a crystallinity in the range of from 1 percent by weight to 30 percent by weight, a heat of fusion in the range of from 2 Joules/gram to 50 Joules/gram, and a DSC melting point in the range of 25° C. to 110° C.; and (b) from 60 to 90 percent by weight of a polyethylene composition selected from the group consisting of high molecular high density polyethylene, high density polyethylene, and linear low density polyethylene.

In another alternative embodiment, the instant invention further provides a process for producing a polymeric composition suitable for films comprising the steps of: (1) selecting from 10 to 40 percent by weight of a masterbatch composition comprising: from 70 to 90 percent by weight of a filler comprising calcium carbonate; and from 10 to 30 percent by weight of a propylene/alpha-olefin copolymer composition, wherein said propylene/alpha-olefin copolymer composition has a crystallinity in the range of from 1 percent by weight to 30 percent by weight, a heat of fusion in the range of from 2 Joules/gram to 50 Joules/gram, and a DSC melting point in the range of 25° C. to 110° C.; (2) selecting from 60 to 90 percent by weight of a polyethylene composition selected from the group consisting of high molecular high density polyethylene, high density polyethylene, and linear low density polyethylene; and (3) compounding said masterbatch composition into said polyethylene composition; (4) thereby producing said polymeric composition suitable for films.

In another alternative embodiment, the instant invention further provides a film comprising a polymeric composition comprising: (a) from 10 to 40 percent by weight of a masterbatch composition comprising: from 70 to 90 percent by weight of a filler comprising calcium carbonate; and from 10 to 30 percent by weight of a propylene/alpha-olefin copolymer composition, wherein said propylene/alpha-olefin copolymer composition has a crystallinity in the range of from 1 percent by weight to 30 percent by weight, a heat of fusion in the range of from 2 Joules/gram to 50 Joules/gram, and a DSC melting point in the range of 25° C. to 110° C.; and (b) from 60 to 90 percent by weight of a polyethylene composition selected from the group consisting of high molecular high density polyethylene, high density polyethylene, and linear low density polyethylene.

In another alternative embodiment, the instant invention further provides a process for making a film comprising the steps of: (1) selecting a polymeric composition comprising: (a) from 10 to 40 percent by weight of a masterbatch composition comprising: from 70 to 90 percent by weight of a filler comprising calcium carbonate; and from 10 to 30 percent by weight of a propylene/alpha-olefin copolymer composition, wherein said propylene/alpha-olefin copolymer composition has a crystallinity in the range of from 1 percent by weight to 30 percent by weight, a heat of fusion in the range of from 2 Joules/gram to 50 Joules/gram, and a DSC melting point in the range of 25° C. to 110° C.; and (b) from 60 to 90 percent by weight of a polyethylene composition selected from the group consisting of high molecular high density polyethylene, high density polyethylene, and linear low density polyethylene; and (2) forming said polymeric composition into a film via blown film process.

### DETAILED DESCRIPTION OF THE INVENTION

The instant invention provides a masterbatch composition, method of producing the same, polymeric compositions suitable for films, and films made therefrom. The masterbatch composition according to the present invention comprises: (a) from 70 to 90 percent by weight of a filler comprising calcium carbonate; and (b) from 10 to 30 percent by weight of a propylene/alpha-olefin copolymer composition, wherein said propylene/alpha-olefin copolymer composition has a crystallinity in the range of from 1 percent by weight to 30 percent by weight, a heat of fusion in the range of from 2 Joules/gram to 50 Joules/gram, and a DSC melting point in the range of 25° C. to 110° C.

### Filler

The masterbatch composition comprises from 70 to 90 percent by weight of one or more fillers, based on the total weight of the masterbatch composition. All individual values and subranges from 70 to 90 weight percent are included herein and disclosed herein; for example, the weight percent of the one or more fillers can be from a lower limit of 70, 75, 76, 80, or 82 weight percent to an upper limit of 80, 82, 85, or 90 weight percent. For example, the weight percent of the one or more fillers may be in the range of from 70 to 80 weight percent, or in the alternative, from 70 to 75 weight percent. Exemplary fillers include, but are not limited to, calcium carbonate, talc, and combinations thereof. In one embodiment, one or more fillers comprise calcium carbonate.

### Propylene/Alpha-Olefin Copolymer Composition

The masterbatch composition according to the present invention comprises from 10 to 30 percent by weight of a propylene/alpha-olefin copolymer composition, based on the total weight of the masterbatch composition. All individual values and subranges from 10 to 30 weight percent are included herein and disclosed herein; for example, the weight percent of the propylene/alpha-olefin copolymer composition can be from a lower limit of 10, 15, 18, 20, 22, 24, or 25 weight percent to an upper limit of 30, 28, 26, or 24 weight percent. For example, the weight percent of the propylene/alpha-olefin copolymer composition may be in the range of from 15 to 28 weight percent, or in the alternative, from 15 to 26 weight percent, or in the alternative, from 15 to 20 weight percent. The propylene/alpha-olefin copolymer composition comprises a propylene/alpha-olefin copolymer such as a propylene/ethylene copolymer. The propylene/alpha-olefin copolymer composition may optionally further comprise, up to for example 20 percent by weight of, one or more polymers, e.g. a random copolymer polypropylene (RCP), made for example via Ziegler-Natta catalysis, based on the total weight of propylene/alpha-olefin copolymer composition. In one particular embodiment, the propylene/alpha-olefin copolymer composition is characterized as having substantially isotactic propylene sequences. “Substantially isotactic propylene sequences” means that the sequences have an isotactic triad (mm) measured by ¹³C NMR of greater than about 0.85; in the alternative, greater than about 0.90; in another alternative, greater than about 0.92; and in another alternative, greater than about 0.93. Isotactic triads are well-known in the art and are described in, for example, U.S. Pat. No. 5,504,172 and International Publication No. WO 00/01745, which refer to the isotactic sequence in terms of a triad unit in the copolymer molecular chain determined by ¹³C NMR spectra.

The propylene/alpha-olefin copolymer composition may have a melt flow rate in the range of from 0.1 to 500 g/10 minutes, measured in accordance with ASTM D-1238 (at 230° C./2.16 Kg). All individual values and subranges from 0.1 to 500 g/10 minutes are included herein and disclosed herein; for example, the melt flow rate can be from a lower limit of 0.1 g/10 minutes, 0.2 g/10 minutes, or 0.5 g/10 minutes to an upper limit of 500 g/10 minutes, 200 g/10 minutes, 100 g/10 minutes, 25 g/10 minutes, or 15 g/10 minutes. For example, the propylene/alpha-olefin copolymer composition may have a melt flow rate in the range of 0.1 to 200 g/10 minutes; or in the alternative, the propylene/alpha-olefin copolymer composition may have a melt flow rate in the range of 0.2 to 100 g/10 minutes; or in the alternative, the propylene/alpha-olefin copolymer composition may have a melt flow rate in the range of 0.2 to 50 g/10 minutes; or in the alternative, the propylene/alpha-olefin copolymer composition may have a melt flow rate in the range of 0.5 to 50 g/10 minutes; or in the alternative, the propylene/alpha-olefin copolymer composition may have a melt flow rate in the range of 1 to 50 g/10 minutes; or in the alternative, the propylene/alpha-olefin copolymer composition may have a melt flow rate in the range of 1 to 40 g/10 minutes; or in the alternative, the propylene/alpha-olefin copolymer composition may have a melt flow rate in the range of 1 to 30 g/10 minutes; or in the alternative, the propylene/alpha-olefin copolymer composition may have a melt flow rate in the range of 1 to 25 g/10 minutes; or in the alternative, the propylene/alpha-olefin copolymer composition may have a melt flow rate in the range of 1 to 20 g/10 minutes; or in the alternative, the propylene/alpha-olefin copolymer composition may have a melt flow rate in the range of 1 to 15 g/10 minutes.

The propylene/alpha-olefin copolymer composition has a crystallinity in the range of from at least 1 percent by weight (a heat of fusion of at least 2 Joules/gram) to 30 percent by weight (a heat of fusion of less than 50 Joules/gram). All individual values and subranges from 1 percent by weight (a heat of fusion of at least 2 Joules/gram) to 30 percent by weight (a heat of fusion of less than 50 Joules/gram) are included herein and disclosed herein; for example, the crystallinity can be from a lower limit of 1 percent by weight (a heat of fusion of at least 2 Joules/gram), 2.5 percent (a heat of fusion of at least 4 Joules/gram), or 3 percent (a heat of fusion of at least 5 Joules/gram) to an upper limit of 30 percent by weight (a heat of fusion of less than 50 Joules/gram), 24 percent by weight (a heat of fusion of less than 40 Joules/gram), 15 percent by weight (a heat of fusion of less than 24.8 Joules/gram) or 7 percent by weight (a heat of fusion of less than 11 Joules/gram). For example, the propylene/alpha-olefin copolymer composition may have a crystallinity in the range of from at least 1 percent by weight (a heat of fusion of at least 2 Joules/gram) to 24 percent by weight (a heat of fusion of less than 40 Joules/gram); or in the alternative, the propylene/alpha-olefin copolymer composition may have a crystallinity in the range of from at least 1 percent by weight (a heat of fusion of at least 2 Joules/gram) to 15 percent by weight (a heat of fusion of less than 24.8 Joules/gram); or in the alternative, the propylene/alpha-olefin copolymer composition may have a crystallinity in the range of from at least 1 percent by weight (a heat of fusion of at least 2 Joules/gram) to 7 percent by weight (a heat of fusion of less than 11 Joules/gram); or in the alternative, the propylene/alpha-olefin copolymer composition may have a crystallinity in the range of from at least 1 percent by weight (a heat of fusion of at least 2 Joules/gram) to 5 percent by weight (a heat of fusion of less than 8.3 Joules/gram). The crystallinity is measured via DSC method, as described above.

The propylene/alpha-olefin copolymer comprises units derived from propylene and polymeric units derived from one or more alpha-olefin comonomers. Exemplary comonomers utilized to manufacture the propylene/alpha-olefin copolymer are C₂, and C₄ to C₁₀ alpha-olefins; for example, C₂, C₄, C₆ and C₈ alpha-olefins.

The propylene/alpha-olefin copolymer comprises from 1 to 40 percent by weight of one or more alpha-olefin comonomers. All individual values and subranges from 1 to 40 weight percent are included herein and disclosed herein; for example, the comonomer content can be from a lower limit of 1 weight percent, 3 weight percent, 4 weight percent, 5 weight percent, 7 weight percent, or 9 weight percent to an upper limit of 40 weight percent, 35 weight percent, 30 weight percent, 27 weight percent, 20 weight percent, 15 weight percent, 12 weight percent, or 9 weight percent. For example, the propylene/alpha-olefin copolymer comprises from 1 to 35 percent by weight of one or more alpha-olefin comonomers; or in the alternative, the propylene/alpha-olefin copolymer comprises from 1 to 30 percent by weight of one or more alpha-olefin comonomers; or in the alternative, the propylene/alpha-olefin copolymer comprises from 3 to 27 percent by weight of one or more alpha-olefin comonomers; or in the alternative, the propylene/alpha-olefin copolymer comprises from 3 to 20 percent by weight of one or more alpha-olefin comonomers; or in the alternative, the propylene/alpha-olefin copolymer comprises from 3 to 15 percent by weight of one or more alpha-olefin comonomers.

The propylene/alpha-olefin copolymer composition has a molecular weight distribution (MWD), defined as weight average molecular weight divided by number average molecular weight (M_{w}/Mₙ) of 3.5 or less; in the alternative 3.0 or less; or in another alternative from 1.8 to 3.0.

Such propylene/alpha-olefin copolymer compositions are further described in details in the U.S. Pat. Nos. 6,960,635 and 6,525,157, incorporated herein by reference. Such propylene/alpha-olefin copolymer compositions are commercially available from The Dow Chemical Company, under the tradename VERSIFY™, or from ExxonMobil Chemical Company, under the tradename VISTAMAXX™.

In one embodiment, the propylene/alpha-olefin copolymer composition is further characterized as comprising (A) between 60 and less than 100, preferably between 80 and 99 and more preferably between 85 and 99, weight percent units derived from propylene, and (B) between greater than zero and 40, preferably between 1 and 20, more preferably between 4 and 16 and even more preferably between 4 and 15, weight percent units derived from at least one of ethylene and/or a C₄₋₁₀ α-olefin; and containing an average of at least 0.001, preferably an average of at least 0.005 and more preferably an average of at least 0.01, long chain branches/1000 total carbons. The maximum number of long chain branches in the propylene/alpha-olefin copolymer is not critical, but typically it does not exceed 3 long chain branches/1000 total carbons. The term long chain branch, as used herein, refers to a chain length of at least one (1) carbon more than a short chain branch, and short chain branch, as used herein, refers to a chain length of two (2) carbons less than the number of carbons in the comonomer. For example, a propylene/1-octene interpolymer has backbones with long chain branches of at least seven (7) carbons in length, but these backbones also have short chain branches of only six (6) carbons in length. Such propylene/alpha-olefin copolymers are further described in details in the U.S. Provisional Patent Application No. 60/988,999 and International Paten Application No. PCT/US08/082,599, each of which is incorporated herein by reference.

### Polymeric Compositions Suitable for Films

The instant invention further provides a polymeric composition suitable for films. The polymeric composition comprises (a) from 10 to 40 percent by weight of the masterbatch composition, as described hereinabove, and (b) from 60 to 90 percent by weight of a polyethylene composition.

The polymeric composition comprises from 10 to 40 percent by weight of the masterbatch composition, as described hereinabove. All individual values and subranges from 10 to 40 weight percent are included herein and disclosed herein; for example, the weight percent of masterbatch composition can be from a lower limit of 10, 12, 15, 20, 25, or 30 weight percent to an upper limit of 20, 25, 30, 35, or 40 weight percent. For example, the weight percent of masterbatch composition may be in the range of from 10 to 35 weight percent, or in the alternative, from 10 to 30 weight percent, or in the alternative, from 15 to 40 weight percent.

The polymeric composition comprises from 60 to 90 percent by weight of a polyethylene composition. All individual values and subranges from 10 to 40 weight percent are included herein and disclosed herein; for example, the weight percent of the polyethylene composition can be from a lower limit of 60, 62, 65, 70, or 75 weight percent to an upper limit of 65, 70, 75, 80, 85, or 90 weight percent. For example, the weight percent of the polyethylene composition may be in the range of from 60 to 85 weight percent, or in the alternative, from 65 to 90 weight percent, or in the alternative, from 70 to 90 weight percent. The polyethylene composition may be selected from the group consisting of high molecular high density polyethylene, high density polyethylene, and linear low density polyethylene. Such polyethylene compositions have a density in the range of 0.905 to 0.965 g/cc; for example, from 0.910 to 0.955 g/cc; or in the alternative, from 0.910 to 0.930 g/cc], and a melt index (I₂) in the range of 0.01 to 5 g/10 minutes; for example, from 0.01 to 3 g/10 minutes; or in the alternative, from 0.2 to 3 g/10 minutes; or in the alternative from 0.5 to 3 g/10 minutes.

Exemplary commercial polyethylene compositions include, but are not limited to, those available under the tradename DOWLEX from The Dow Chemical Company, EXCEED from ExxonMobil Chemical Company, SCLAIR from Nova Chemical Company, ALATHON from Lyondell-Basell Industries.

In another alternative embodiment, the instant invention further provides a process for producing a polymeric composition suitable for films comprising the steps of: (1) selecting from 10 to 40 percent by weight of a masterbatch composition, as described hereinabove; and (2) selecting from 60 to 90 percent by weight of a polyethylene composition; and (3) compounding the masterbatch composition into said polyethylene composition; (4) thereby producing said polymeric composition suitable for films. Masterbatch compositions, as described above, may be compounded into various polyethylene compositions via different methods generally known to a person of ordinary skill in the art; for example, via a melt kneading device such as an extruder, for example a single screw extruder or a twin screw extruder, or a Banbury mixer.

### Films

The polymeric compositions according to the present invention may be formed into films. In one embodiment, the instant invention provides a film comprising the polymeric composition, as described hereinabove.

The inventive films may, for example, have a thickness in the range of from 5 to 125 micrometer; for example, from 5 to 75 micrometer; or in the alternative, from 5 to 50 micrometer; or in the alternative, from 5 to 25 micrometer; or in the alternative, from 10 to 25 micrometer.

Such films may be formed via any method; for example, such films may be formed via blown film extrusion process. In a blown film extrusion process, the molten polymeric composition is extruded through a ring-shaped die around a mandrel. The tube or sleeve so formed is expanded around an air bubble, is cooled, and then is rolled into a flattened tube and wound up. The blowup ratio (bubble diameter/die diameter) may range of less than 5, for example less than 4, or in the alternative less than 2.5. The film may be oriented; for example, the film may be biaxially oriented. In one embodiment, the instant invention provides a process for making a film comprising the steps of: (1) selecting the polymeric composition, as described hereinabove; and (2) forming the polymeric composition, as described hereinabove, into a film via blown film process.

Such films may be used to form grocery bags, shopping bags, liners, wrapping sheets, and the like.

### EXAMPLES

The following examples illustrate the present invention but are not intended to limit the scope of the invention. The examples of the instant invention demonstrate that the polymeric compositions according to the present invention having improved dart impact and elongation at yield while maintaining acceptable tear strength in both machine direction and transverse direction.

### Formulation Components

50GF003: is a high molecular weight high density polyethylene resin, having a density of approximately 0.952 g/cc, and I₅ of approximately 0.3 g/10 minutes, provided by Reliance Industries LTD.
Comparative Masterbatch A: comprises approximately 20 percent by weight of a linear low density polyethylene (LLDPE) (having a density of approximately 0.926 g/cc and a melt index I₂ of approximately 50 g/10 minutes) and approximately 80 percent by weight of calcium carbonate.
Inventive Masterbatch 1: comprises approximately 20 percent by weight of a propylene/ethylene copolymer (available under the tradename VERSIFY™ from The Dow Chemical Company) (having a melt flow rate of approximately 25 and comprising 12 percent by the weight of units derived from ethylene) and approximately 80 percent by weight of calcium carbonate.

### Process for Forming Films

The Comparative Compositions 1 and 2, and Inventive Composition 1, as shown in Table 1, are formed into Comparative Films 1 and 2 and Inventive Film 1, respectively, according to the following process. The Comparative Compositions 1 and 2, and Inventive Composition 1, as shown in Table 1, were each melted and extruded through a ring shaped die around a mandrel. The tubes or sleeves so formed where expanded around an air bubble, where cooled, and then were rolled into a flattened tube and wound up. The blowup ratio (bubble diameter/die diameter) was approximately 2.75:1. The films had a thickness of approximately 20 μm. The temperature profile for the extruder was approximately in the range of hundred 85 to 200° C. The melt temperature was approximately 210 to 220° C. The Comparative Films 1 and 2 and Inventive Film 1 were tested for their properties, and the results are reported in Table 2.

### Test Methods

Test methods include the following:

Density was measured according to ASTM D 792-03, Method B, in isopropanol.

Melt index (I₂) is measured at 190° C. under a load of 2.16 kg according to ASTM D-1238-03.

Melt index (I₅) is measured at 190° C. under a load of 5 kg according to ASTM D-1238-03.

Melt index (I₁₀) is measured at 190° C. under a load of 10 kg according to ASTM D-1238-03.

Melt index (I₂₁) is measured at 190° C. under a load of 21.6 kg according to ASTM D-1238-03.

The present invention may be embodied in other forms without departing from the spirit and the essential attributes thereof, and, accordingly, reference should be made to the appended claims, rather than to the foregoing specification, as indicating the scope of the invention.

TABLE 1

| | | Comparative | Inventive |
|---|---|---|---|
| | 50GF003 | Masterbatch A | Masterbatch 1 |
| | (WT %) | (WT %) | (WT %) |
| Comparative | 100 | — | — |
| Polymeric | | | |
| Composition 1 | | | |
| Comparative | 80 | 20 | — |
| Polymeric | | | |
| Composition 2 | | | |
| Inventive | 80 | — | 20 |
| Polymeric | | | |
| Composition 1 | | | |

TABLE 2

| | Test Method | Com- | Com- | |
|---|---|---|---|---|
| | or Test | parative | parative | Inventive |
| | Device | Film 1 | Film 2 | Film 1 |
| Average Thickness | Micrometer | 21 | 22 | 21 |
| (μm) | | | | |
| Elongation at Yield in | ASTM-D 638 | 9 | 5 | 10 |
| Machine Direction (%) | | | | |
| Elongation at Yield in | ASTM-D 638 | 8 | 5 | 5 |
| Transverse Direction | | | | |
| (%) | | | | |
| Tear Strength in | ASTM-D | 0.9 | 1.2 | 1.1 |
| Machine Direction | 1922 | | | |
| (gm/micrometer) | | | | |
| Tear Strength in | ASTM-D | 9.5 | 7.7 | 7.8 |
| Transverse Direction | 1922 | | | |
| (gm/micrometer) | | | | |
| Dart Impact | ASTM-D | 6.5 | 5.6 | 7.4 |
| (gm/micrometer) | 1709 | | | |

We claim:

1. A masterbatch composition comprising:
from 70 to 90 percent by weight of a filler comprising calcium carbonate; and
from 10 to 30 percent by weight of a propylene/alpha-olefin copolymer composition, wherein said propylene/alpha-olefin copolymer composition has a crystallinity in the range of from 1 percent by weight to 30 percent by weight, a heat of fusion in the range of from 2 Joules/gram to 50 Joules/gram, and a DSC melting point in the range of 25° C. to 110° C.

2. A method for producing a masterbatch composition comprising the steps of:
selecting a filler comprising calcium carbonate;
selecting a propylene/alpha-olefin copolymer composition, wherein said propylene/alpha-olefin copolymer composition has a crystallinity in the range of from 1 percent by weight to 30 percent by weight, a heat of fusion in the range of from 2 Joules/gram to 50 Joules/gram, and a DSC melting point in the range of 25° C. to 110° C.;
compounding that filler into said propylene/alpha-olefin copolymer composition; and
thereby producing said masterbatch composition, wherein said masterbatch composition comprises from 70 to 90 percent by weight of that filler and from 10 to 30 percent by weight of said propylene/alpha-olefin copolymer composition.

3. A polymeric composition suitable for films comprising:
from 10 to 40 percent by weight of a masterbatch composition comprising:
from 70 to 90 percent by weight of a filler comprising calcium carbonate; and
from 10 to 30 percent by weight of a propylene/alpha-olefin copolymer composition, wherein said propylene/alpha-olefin copolymer composition has a crystallinity in the range of from 1 percent by weight to 30 percent by weight, a heat of fusion in the range of from 2 Joules/gram to 50 Joules/gram, and a DSC melting point in the range of 25° C. to 110° C.; and
from 60 to 90 percent by weight of a polyethylene composition.

4. A process for producing a polymeric composition suitable for films comprising the steps of:
selecting from 10 to 40 percent by weight of a masterbatch composition comprising:
from 70 to 90 percent by weight of a filler comprising calcium carbonate; and
from 10 to 30 percent by weight of a propylene/alpha-olefin copolymer composition, wherein said propylene/alpha-olefin copolymer composition has a crystallinity in the range of from 1 percent by weight to 30 percent by weight, a heat of fusion in the range of from 2 Joules/gram to 50 Joules/gram, and a DSC melting point in the range of 25° C. to 110° C.;
selecting from 60 to 90 percent by weight of a polyethylene composition; and
compounding said mater batch composition into said polyethylene composition;
thereby producing said polymeric composition suitable for films.

5. A film comprising:
a polymeric composition comprising:
from 10 to 40 percent by weight of a masterbatch composition comprising:
from 70 to 90 percent by weight of a filler comprising calcium carbonate; and
from 10 to 30 percent by weight of a propylene/alpha-olefin copolymer composition, wherein said propylene/alpha-olefin copolymer composition has a crystallinity in the range of from 1 percent by weight to 30 percent by weight, a heat of fusion in the range of from 2 Joules/gram to 50 Joules/gram, and a DSC melting point in the range of 25° C. to 110° C.; and
from 60 to 90 percent by weight of a polyethylene composition.

6. A process for making a film comprising the steps of:
selecting a polymeric composition comprising:
from 10 to 40 percent by weight of a masterbatch composition comprising:
from 70 to 90 percent by weight of a filler comprising calcium carbonate; and
from 10 to 30 percent by weight of a propylene/alpha-olefin copolymer composition, wherein said propylene/alpha-olefin copolymer composition has a crystallinity in the range of from 1 percent by weight to 30 percent by weight, a heat of fusion in the range of from 2 Joules/gram to 50 Joules/gram, and a DSC melting point in the range of 25° C. to 110° C.; and
from 60 to 90 percent by weight of a polyethylene composition; and
forming said polymeric composition into a film via blown film process.
